(19) United States
(12) Patent Application Publication
(10) Pub. No.: US 2020/0086492 A1
(43) Pub. Date: Mar. 19, 2020

(54) TARGET ACQUIRING DEVICE AND METHOD FOR OPERATING THE DEVICE

(71) Applicant: LINGDONG TECHNOLOGY(BEIJING)CO.LTD, Beijing (CN)

(72) Inventor: SHOULIANG CHEN, Beijing (CN)

(21) Appl. No.: 16/571,174

(22) Filed: Sep. 15, 2019

(30) Foreign Application Priority Data
Sep. 18, 2018 (CN) 201811085489.1

(51) Int. Cl. B25J 9/16; B25J 15/08; B25J 15/06

(52) U.S. Cl. CPC B25J 9/1697; B25J 15/0616; B25J 15/08

(57) ABSTRACT

A robot with new camera design and method for operating the robot is disclosed. The robot includes a control module configured to control and drive a multi-degree-of-freedom attachment system. The multi-degree-of-freedom attachment system attaches to a target acquiring device. The target acquiring device is configured to acquire a target located on an axis of acquisition of a target, wherein the axis is an extension line going through the target acquiring device. The robot further includes a vision sensor, located on an axis of acquisition of a target. The vision sensor acquires the image signal on the direction of the axis of acquisition of a target while the robot operates. In accordance with the image signal, the control module drives the multi-degree-of-freedom attachment system to adjust the attitude of the target acquiring device so as to adjust the axis of acquisition of a target to the direction towards the target.

### BACKGROUND OF THE INVENTION

### 1. Field of the Invention

Embodiments presented herein generally relate to a robotic arm of both industrial and civil use and the method for operating it. The robotic arm is with a new camera design.

### 2. Description of the Prior Art

With the development of science and technology, more and more smart robots are used in a wide range of fields such as manufacture and disaster relief and rescue. Most of modern robotic arms do not equip with a vision system. The modern robotic arms operate only under a defined working environment and/or accomplish pre-defined tasks, for example, to operate with a given coordinate tracks and under a preprogrammed steps, which are offered by the designer. Defects of this design are that the robotic arms are not capable to operate under an unexpected working environment and/or to self-define operating steps.

For other robotic arms, although equipped with a vision system, the vision systems are not disposed at the same position with the grasping structure. In this case, the vision system is easy to observe the targets and determine the coordinates when the targets are easily observed. The drawbacks of such design are the vision system which is not able to determine the target coordinates correctly under a complex environment where the target is blocked. For example, when the robotic arm is to grasp a target from a pinhole, the vision system fails to observe and determine the coordinates correctly and then fails to guide the grasping structure to accomplish the grasp.

### SUMMARY OF THE INVENTION

The present invention encloses a robotic arm with a new design of vision system and method for using the robotic arm. The vision system is disposed in the grasping structure. For example, the vision system includes a camera. If the grasping structure includes a sucker, the camera is disposed within a hole of the sucker. If the grasping structure includes a robotic arm, the camera is disposed near the palm of the robotic hand. The robotic arm enclosed in the present invention can be used in a complex working environment, for example, the target is blocked.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic view of a robotic arm according to one embodiment.

FIG. 2 is a schematic view of a grasping structure according to one embodiment.

FIG. 3 is a schematic view of a grasping structure according to another embodiment.

FIG. 4 is a flow chart of method for operating a robotic arm.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled to”, “attached to” and “installed” and variations thereof herein are used broadly and encompass direct and indirect connections and installations.

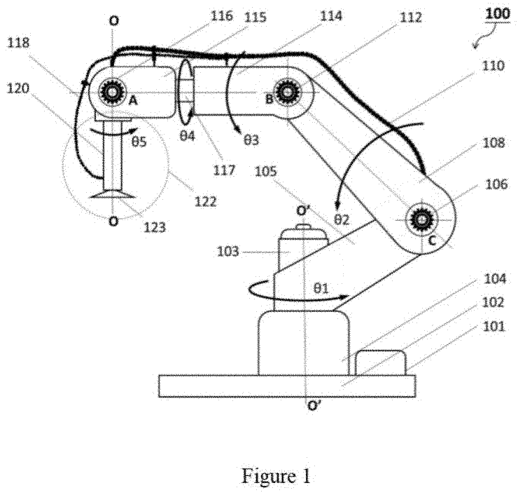

FIG. 1 is a schematic view of a robotic arm according to one embodiment. The foresaid robotic arm includes a base 102, a multi-degree-of-freedom attachment system, a grasping structure 122 and a control module 101 as well as control connections 110,118. A first end of the multi-degree-of-freedom attachment system attaches to the base 102 and a second end of the multi-degree-of-freedom attachment system attaches to the grasping structure 122. The movement of the robotic arm is controlled by the control module 101.

The multi-degree-of-freedom attachment system includes a multi-connecting-rod structure which is hinged by multiple hinges of same or different types. The multi-connecting-rod structure includes at least one connecting rod and at least one hinge, wherein at least one end of each connecting rod connects one of the hinges and each hinge connects at least one end of one of the connecting rods. Each hinge at least includes one drive device (such as an engine) and each drive device connects a corresponding hinge to drive the hinge to rotate.

The multi-connecting-rod structure includes a first connecting rod 104, a second connecting rod 105, a third connecting rod 108, a fourth connecting rod 114 and a fifth connecting rod 115. The first connecting rod 104 connects the base 102. The second connecting rod 105 attaches to the first connecting rod 104 by a first hinge 103. The first hinge 103 comprises a rotor. As shown in FIG. 1, the axis line O′-O′ of the rotation is normal to the base 102. The first hinge 103 includes a driving system. For example, the first hinge 103 includes a first driving motor (i.e. a first driving engine). The rotation of the first driving motor is controlled by the control module 101. In such way, the second connecting rod is capable to rotate around the axis line O′-O′ in a direction of θ1.

The third connecting rod 108 attaches to the second connecting rod 105 by a second hinge 106. The second hinge 106 comprises a rotor. As shown in FIG. 1, the foresaid rotor cuts through the axle center C of the second hinge 106 in a direction perpendicular to the surface. The second hinge 106 includes a driving system. For example, the second hinge 106 includes a second driving motor (i.e. a second driving engine). The rotation of the second driving motor is controlled by the control module 101. In such way, the third connecting rod 108 is capable to rotate around the axle center C of the second hinge 106 in a direction of θ2.

The fourth connecting rod 114 attaches to the third connecting rod 108 by a third hinge 112. The third hinge 112 comprises a rotor. As shown in FIG. 1, the rotor cuts through the axle center B of the third hinge 112 in a direction perpendicular to the surface. The third hinge 112 includes a driving system. For example, the third hinge 112 includes a third driving motor (i.e. a third driving engine). The rotation of the third driving motor is controlled by the control module 101. In such way, the fourth connecting rod 114 is capable to rotate around the axle center B of the third hinge 112 in a direction θ3.

The fifth connecting rod 115 attaches to the fourth connecting rod 114 by a fourth hinge 117. The fourth hinge 117 comprises a rotor A-B. As shown in FIG. 1, the rotor A-B is parallel to the surface. For example, the rotor A-B cuts through the axel center B of the third hinge and an axel center A of a fifth hinge 116. Wherein the fifth hinge 116 attaches to the fifth connecting rod 115 and the grasping structure 122. The fourth hinge 117 includes a driving system. For example, the fourth hinge 117 includes a fourth driving motor (i.e. a fourth driving engine). The rotation of the fourth driving motor is controlled by the control module 101. Hence, the fifth connecting rod is capable to rotate around the rotor A-B of the fourth hinge 117 in a direction θ4.

The grasping structure 122 attaches to the fifth connecting rod 115 by the fifth hinge 116. As depicted earlier, the fifth hinge 116 comprises a rotor. As shown in FIG. 1, the rotor cuts through the axel center A of the fifth hinge 116 in a direction perpendicular to the surface. The fifth hinge 116 includes a driving system. For example, the fifth hinge 116 includes a fifth driving motor (i.e. a fifth driving engine). The rotation of the fifth driving motor is controlled by the control module 101. Hence, the grasping structure 122 is capable to rotate around the rotor of the fifth hinge 116 in a direction θ5.

As described previously, the multi-degree-of-freedom attachment system includes two ends. A first end attaches to the base 102. A second end attaches to the grasping structure 122. As shown in FIG. 1, the multi-degree-of-freedom attachment system includes a multi-connecting-rod structure which is hinged by hinges. While, the multi-degree-of-freedom attachment system may comprise other mechanical structures which is not limited to the embodiments described in present disclosure.

The control module 101 is a general name for function controlling devices of the robotic arm and is configured to compute and control the robotic arm to move, sense and apply logics. For example, the control module 101 receives visual messages from the robotic arm and makes a movement decision based on the visual messages. Then the control module controls the output power, rotating angle and rotating speed of the first driving motor, the second driving motor, the third driving motor, the fourth driving motor and the fifth driving motor based on the movement decision so that the grasping structure can aim at the direction where the target is. The control module can be disposed at any location in the robotic arm. As shown in FIG. 1, as an example, the control module 101 is disposed on the base 102.

The grasping structure 122 includes a target acquiring device 120 and vision system (e.g. laser and/or camera, not shown in FIG. 1). The target acquiring device 120 includes a target acquisition end 123 and is configured to acquire objects on the axis line O-O through the target acquisition end 123. The axis line O-O is an extension line going through the target acquiring device 120. The target acquiring device connects the control module 101 through the first control connection 118. The vision system is located on the target acquiring device 120 and connects the control module 101 through the second control connection 110.

The vision system receives images on the axis of acquisition of a target and turns the images to electrical signals which will be transmitted to the control module 101 through the second control connection 110. When receiving the electrical signals, the control module 101 analyzes the images. If the images contain a to-be-grasped target, the control module 101 may compute and confirm the coordinates of the target relative to the target acquisition end 123 and then control the output power, rotating angle and rotating speed of the first driving motor, the second driving motor, the third driving motor, the fourth driving motor and the fifth driving motor. In such way, the grasping structure 122 can change its location in one or more degrees of freedom to align the axis line O-O with the target and move the target acquiring device 120 to the location adjacent to the target. During this process, the control module 101 receives real-time feedbacks from vision system and real-time computes and confirms the coordinates of the target relative to the target acquisition end 123 till the distance value between the target acquiring device 120 and the target reaches a default. Then the control module 101 controls and/or drives the target acquisition end 123 to acquire the target through the first control connection 118.

In conclusion, the servo drive system includes the control system, vision system and multiple driving devices of the robotic arm as shown in FIG. 1. The sensor includes the vision system (e.g. laser and/or camera). The multiple driving devices includes the first driving motor, the second driving motor, the third driving motor, the fourth driving motor, the fifth driving motor and the target acquisition end 123. The control system includes the control module 101 and is coupled to the vision system and the multiple driving devices. The control system controls the multiple driving devices by image signals transmitted from vision system. The driving devices drive the multi-degree-of freedom attachment system and adjust the position of the target acquiring device in one or more degrees of freedom so that to adjust the posture of the target acquiring device in space and align the axis line O-O toward the target. The target acquiring device is moved along the axis line O-O to the vicinity of the target. Finally, the target acquisition end is driven to acquire the target.

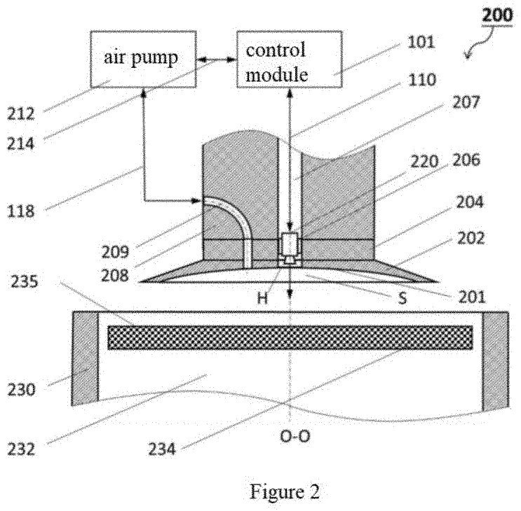

FIG. 2 is a schematic view of the grasping structure 122 according to one embodiment. According to this embodiment, the grasping structure 122 includes a sixth connecting rod 208, a base 204, a target acquisition end 202 and a vision sensor 220.

The sixth connecting rod 208 connects the base 204. The target acquisition end 202 is a sucking device. The sucking device can be a sucker, configured to suck the surface of a target by creating air negative pressure. The sucking device can be a skin structure, configured to enfold a part of a target and complete the grasp by surface friction between the skin and the target. According to the FIG. 2, the sucker will be used as an example to illustrate the grasping structure 122. It can be understood that the target acquisition end 202 can be any type of sucking device but the present invention is not limited thereto.

The sucker 202 is made of well-sealed and well-stretchable materials, for example, rubber or other applicable materials. The sucker 202 includes a sucking surface 201 and an air flow path 209. One end of the air flow path 209 is opened on the sucking surface 201 and the other end is opened on the side wall of the sixth connecting rod 208, coupled to the air pump 212 (i.e. vacuum pump) through the first control connection 118. The control connection 118 can be an add-in tube. The air pump 212 couples to the control module 101 through a third control connection 214.

Acquiring a Target:

As the sucking surface 201 touches an upper surface 235 of a target 234, a space S forms between the sucking surface 201 and the upper surface 235. By air extracting signals transmitted from the control module 101, the air pump 212 can extract air from the space S through the add-in tube 118 and the air flow path 209 and air negative pressure reaches a first default. Pressure force applies on the sucking surface 201. When the pressure force is larger than the weight of the target 234, the target acquiring device 120 sucks the target 234 and the robotic arm can lift the target 234.

Releasing a Target:

By air-filled signals transmitted from the control module 101, the air pump 212 can fill air into the space S through the add-in tube 118 and the air flow path 209 and the air negative pressure resumes a second default (e.g. atmospheric pressure). Pressure force applies on the sucking surface 201. When the pressure force is lower than the weight of the target 234, the target acquiring device 120 releases the target 234.

The sucking surface 201 can be an arc curved surface 201 (as shown in FIG. 2), for example, a part of sphere, ellipsoid and other curved surfaces. The sucking surface 201 also can be other shape. The present invention is not limited thereto.

The air flow path 209 not only opens a hole on the sucking surface 201 to form a path but also opens more holes to form more paths. The hole is but not limited to round hole, square hole and/or other shapes. The location of the hole can be in the middle of the sucking surface 201 or other location where the air negative pressure can be applied to the space S and sucking process can be completed.

The grasping structure 200 in FIG. 2 further includes a second connecting path 207 embedded within the grasping structure 200. The second connecting path 207 may be a through-hole and goes through the sucker 202, the base 204 and the sixth connecting rod 208. The central axis of the through-hole is the axis line O-O. The hole opened on the sucking surface 201 by the second connecting path 207 is named as H. The location of H can be in the middle of the sucker 202 and other applicable places on the sucking surface 201. The vision sensor 220 is disposed within the second connecting path 207. The vision sensor 220 detects external environmental in line with the axis line O-O. In such manner, when the robotic arm acquires the target 234 by the sucker 202, the vision sensor 220 can aim at the target 234 all the time and the image captured by vision sensor 220 guides the control module 101 to locate the sucker 202 precisely and records the sucking process from the sucker 202's viewpoint. Even in a narrow space, e.g. in a hole 232 as shown in FIG. 2, the vision sensor 220 still guides the sucker 202 to dig precisely into the narrow space and to acquire the target 234 successfully.

The vision sensor 220 connects the inner wall of the second connecting path 207 through the sealing ring 206 and then seals the second connecting path 207. By doing so, the space S becomes a hermetic space and the air negative pressure in space S is generated by the air pump 212 and the control module 101.

The vision sensor 220 can be kind of sensor that passively receives light, such as camera and video camera; the vision sensor 220 can also be kind of sensor that sends out detecting signals proactively and receives detecting signals reflected back to the sensor, such as laser sensor, ultrasonic sensor, radar. The vision sensor 220 is any kind of the foresaid sensors or combination of them. No matter passively receiving signals or proactively detecting signals, the vision sensor 220 senses the external environmental information and couples to the control module 101 by the second control connections 110. The vision sensor 220 transmits the external environmental information in a form of picture to the control module 101.

Video camera as the vision sensor 220 is illustrative of an example herein for explaining the characteristic and the function of the vision sensor. When the air in space S is extracted by the air pump 212, the space S will be deflated and then the sucking surface 201 will be attached to the upper surface 235 of the target 234. The video camera 220 is disposed inside the second connecting path 207 so that to avoid the bad effect on the attachment between the sucking surface 201 and the upper surface 235. As shown in FIG. 2, the video camera 220 is disposed within the hole H so that the camera will not exposed outside the sucking surface 201. In such manner, when the sucking surface 201 sucks the target 234, the camera will not touch the target. At the same time, to adapt the air negative pressure in space S, the structure of the video camera 220 should be strengthened. For example, the outer shell of the video camera 220 should be hard enough and the mirror-pane glass of the camera should be thickened.

The video camera 220 couples to the control module 101 through the second control connection 110, which is disposed inside the sixth connecting rod 208. The second control connection 110 can be wires for data transmission and/or power providing.

As shown in FIG. 1, during the working process of the robotic arm, the video camera 220 receives images from the direction of the axis line O-O and transmits the images in a form of electrical signals to the control module 101 through the second control connection 110. The control module 101 will analyze the images upon receiving the electrical signals. If the images contain the target 234, the control module 101 will compute the coordinates of the target 234 relative to the sucker 202 and then will control the output power and the rotating angle θ1˜θ5 of the first driving motor, the second driving motor, the third driving motor, the fourth driving motor and the fifth driving motor. In such manner, the axis line O-O of the grasping structure 122 will aim at the target 234 and will rotate the sixth connecting rod 208 along the axis line O-O to approach to the target 234 continuously. The control module 101 receives the electrical signals transmitted from the video camera 220 and computes the coordinates of the target 234 relative to the sucker 202 till that the sucker 202 touches the upper surface 235 of the target 234. Then, the control module 101 controls the air pump 212 to extract the air out from the space S and the target will be lifted up when the air negative pressure excesses the first default.

As stated above, when the robotic arm uses the sucker 202 to grasp the target 234, the vision sensor 220 is always oriented to the target 234 and transmits the images captured in view of the sucker 202 to the control module 101. The control module 101 is guided by the vision sensor 220 to locate the target 234 precisely and the process of sucker 202 grasping the target 234 will be recorded in view of the sucker 202. Even if the target 234 is in a narrow space, the vision sensor 220 still observes inside the space and guides the sucker 202 into the space precisely and then takes the target 234 out from the space successfully. At the same time, the operator who is operating the robotic arm is able to know the to-be-grasped location inside a narrow space and can stop the grasping if there is a problem or risk.

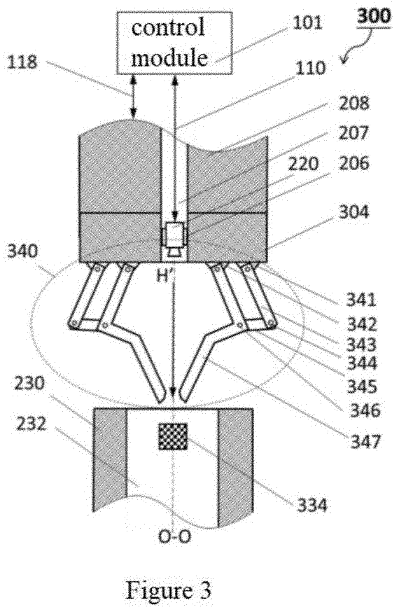

In FIG. 3, another embodiment of the grasping structure is disclosed. The target acquisition end is a grabbing mechanism. It is to be understood that the embodiment in FIG. 2 is not opposite to that in FIG. 3 and the two embodiments can appears at the same time if the robotic arm has two or more grasping structures.

As shown in FIG. 3, the grasping structure 122 includes the sixth connecting rod 208, the base 304, the target acquisition end 340 and the vision sensor 220.

Wherein the sixth connecting rod 208 is coupled to the base 304 through a rotating device, which is coupled to the control module 101 through the first control connection 118. The control module 101 controls the base 304 to drive the target acquisition end 340 to rotate around the axis line O-O under control.

In one embodiment, the target acquisition end 202 can be a robotic hand. The robotic hand is coupled to the base 304 and includes at least two fingers, namely the first finger and the second finger. The first finger is coupled to the first base 304 through a first hinge and swings around the first hinge. The second finger is coupled to the first base 304 through the hinge and swings around the first hinge. As the first finger and the second finger rotate oppositely, the robotic hand completes the grasp.

For example, the first finger and the second finger are connecting-rod structures and are coupled to each other through hinges. The first finger includes at least a finger connecting rod 347, a driving connecting rod 343 and a middle connecting rod 345. The finger connecting rod 347 is coupled to the base 304 through a hinge 342 and is coupled to the middle connecting rod 345 through a hinge 346. The middle connecting rod 345 is coupled to the driving connecting rod 343 through a hinge 344 and the driving connecting rod 343 is coupled to the base 304 through a hinge 341. The hinge 341 is coupled to the driving device, e.g. a finger driving motor. The driving motor is coupled to the control module 101 through the first control connection 118. Controlled by the control module 101, the driving motor is able to drive the driving connecting rod 343 rotate through the hinge 341 at a predetermined angle. The rotation of the driving connecting rod 343 causes the rotation of the finger connecting rod 347 through the middle connecting rod 345. A four-connecting-rod structure is comprised of the base 304, the finger connecting rod 347, the driving connecting rod 345 and hinges 341,342,344,346. It is easy to be understood of the above mentioned coupling structure.

The second finger and the first finger are symmetrically disposed about the axis line O-O. The second finger has the same structure with the first finger and descriptions are omitted herein for simplicity.

As the control module 101 controls the first finger and the second finger to rotate oppositely (towards the axis line O-O), the first finger and the second finger closes and the robotic hand completes the grasping. As the control module 101 controls the first finger and the second finger rotates oppositely (away from the axis line O-O), the first finger and the second finger opens and the robotic hand completes releasing.

The vision sensor 220 is located on the base, between the first hinge and the second hinge. As shown in FIG. 3, the grasping structure 300 further includes the second connecting path 207. The second connecting path 207 may be a through-hole and goes through the base 304 and the sixth connecting rod 208. The central axis of the through-hole is the axis line O-O. The hole opened on the base 304 by the second connecting path 207 is named as H′. The location of H′ can be in the middle of the base 304 and other applicable places on the base 304. The vision sensor 220 is disposed within the second connecting path 207. The vision sensor 220 can be disposed within the hole H′ and the camera of the vision sensor 220 can be exposed out of the hole H′ or not. The vision sensor 220 is coupled to the control module 101 through the second control connection 110. The second control connection 110 is disposed within the second connecting path 207.

In such manner, the vision sensor 220 detects external environmental in line with the axis line O-O. When the robotic arm acquires the target 334 by the robotic hand (the first finger and the second finger), the vision sensor 220 can aim at the target 334 all the time and the images captured by the vision sensor 220 guides the control module 101 to locate the first finger and the second finger precisely and records the grasping process from the robotic hand's viewpoint. Even in a narrow space, e.g. in a hole 232 as shown in FIG. 3, the vision sensor 220 still guides the robotic hand to dig precisely into the narrow space and to acquire the target 334 successfully.

The type of the vision sensor 220 is same with the vision sensor shown in FIG. 2 and detailed description is omitted herein.

Video camera as the vision sensor 220 is illustrative of an example herein for explaining the characteristic and the function of the vision sensor. The embedded camera 220 receives images from the direction of the axis line O-O and transmits the images in a form of electrical signals to the control module 101 through the second control connection 110. The control module 101 will analyze the images upon receiving the electrical signals. If the images contain the target 334, the control module 101 will compute the coordinates of the target 334 relative to the robotic hand and then will control the output power and the rotating angle θ1˜θ5 of the first driving motor, the second driving motor, the third driving motor, the fourth driving motor and the fifth driving motor. In such manner, the axis line O-O of the grasping structure will aim at the target 334 and will rotate the sixth connecting rod 208 to approach to the target 334 continuously. The control module 101 receives the electrical signals transmitted from the video camera 220 and computes the coordinates of the target 334 relative to the robotic hand (the first finger and the second finger) till that the front ends of the first finger and the second finger are located at two sides of the target 334. Then, the control module 101 controls the first finger and the second finger to rotate oppositely (towards the axis line O-O). The first finger and the second finger close and the robotic hand completes the grasping of the target 334. If the control module 101 controls the first finger and the second finger to rotate oppositely (away from the axis line O-O), the first finger and the second finger opens and the robotic hand completes releasing of the target 334.

As stated above, when the robotic arm uses the robotic hand to grasp the target 334, the vision sensor 220 is always oriented to the target 334 and transmits the images captured in view of the robotic hand to the control module 101. The control module 101 is guided by the vision sensor 220 to locate the target 334 precisely and the process of the robotic hand grasping the target 334 will be recorded in view of the robotic hand. Even if the target 334 is in a narrow space, the vision sensor 220 still observes inside the space and guides the robotic hand into the space precisely and then takes the target 334 out from the space successfully. At the same time, the operator who is operating the robotic arm foreknows the to-be-grasped location and can stop the grasping if there is a problem or risk.

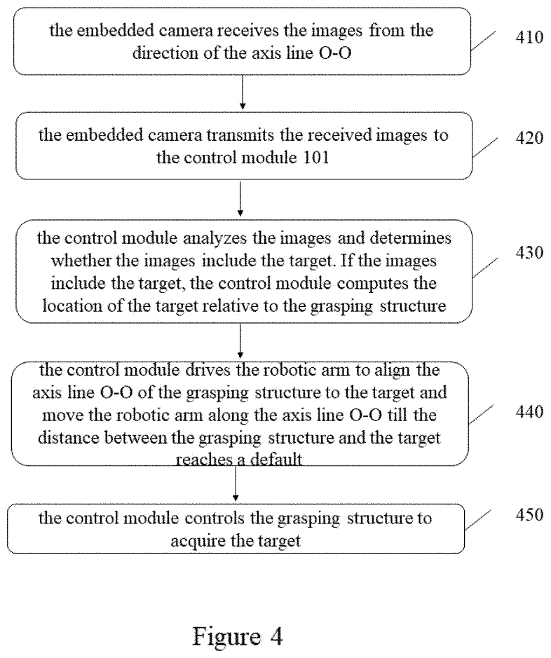

FIG. 4 depicts a method for controlling the robotic arm. The robotic arm can be the embodiment shown in FIG. 1 and the grasping structure can be any of or a combination of the embodiments described in FIG. 2 and/or FIG. 3. The method comprises:

S410: The embedded camera 220 receives the images from the direction of the axis line O-O.

S420: The embedded camera 220 transmits the received images to the control module 101.

S430: The control module 101 analyzes the images and determines whether the images include the target 234 and/or 334. If the images include the target 234 and/or 334, the control module 101 computes the location of the target 234 and/or 334 relative to the grasping structure.

S440: The control module 101 drives the robotic arm to align the axis line O-O of the grasping structure to the target and move the robotic arm along the axis line O-O till the distance between the grasping structure and the target reaches a default.

As the control module 101 moves the six connecting rod 208 to approach to the target 234 and/or 334 continuously, the control module 101 receives the image signals transmitted by the video camera 220 in real time and computes the coordinates of the target 234 relative to the grasping structure (e.g. the sucker 220 and/or robotic hand) in real time till the distance between the grasping structure and the target reaches a default. Then stop moving the grasping structure. Different grasping structures have different ways to determine a default. Detailed description is omitted herein as we have discussed these above in FIG. 2 and FIG. 3.

S450: The control module 101 controls the grasping structure to acquire the target. Different grasping structures have different ways to control and complete the acquiring. Detailed description is omitted herein as we have discussed these above in FIG. 2 and FIG. 3.

The present invention encloses a robotic arm with a new design of vision system and method for using the robotic arm. The vision system is disposed in the grasping structure. For example, the vision system includes a camera. If the grasping structure includes a sucker, the camera is disposed within a hole of the sucker. If the grasping structure includes a robotic arm, the camera is disposed near the palm of the robotic hand. The robotic arm enclosed in the present invention can be used in a complex working environment, for example, if the target is blocked.

In conclusion, these and other objectives of the present invention will no doubt become obvious to those of ordinary skill in the art after reading the following detailed description of the preferred embodiment that is illustrated in the various figures and drawings. Numerous modifications and alterations of the device and method may be made while retaining the teachings of the invention.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within ±20% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A target acquiring device, configured to acquire a target located on an axis of acquisition of a target;
wherein the axis is an extension line going through the target acquiring device;
wherein the target acquiring device comprises a vision sensor, located on the axis of acquisition of a target and configured to acquire the image on the direction of the axis of acquisition of a target.

2. The target acquiring device of claim 1, wherein the target acquiring device includes a first base and a mechanical arm, wherein the mechanical arm includes:
a first hinge;
a first finger, attached to the first base by the first hinge and capable to make a grasp swinging around the first hinge;
a second hinge; and
a second finger, attached to the first base by the second hinge and capable to make the grasp swinging around the second hinge.

3. The target acquiring device of claim 2, wherein the target acquiring device further includes a rotating device attached to the first base; wherein the rotating device rotates around the axis of acquisition of a target so as to drive the first base and the mechanical arm to rotate around the axis.

4. The target acquiring device of claim 2, wherein the vision sensor is located on the first base and between the first hinge and the second hinge.

5. The target acquiring device of claim 1, wherein the target acquiring device further comprises:
a second base;
a sucking device, including a curved surface configured to suck the target, wherein the curved surface includes at least one hole where the vision sensor is, and the curved surface is higher than the vision sensor.

6. The target acquiring device of claim 5, wherein the vision sensor is fixed to the at least one hole on the curved surface by a sealing ring.

7. The target acquiring device of claim 5, wherein the vision sensor includes a reinforcement structure and a thicken camera.

8. The target acquiring device of claim 5, further comprising a transmission line, wherein the transmission line is attached to the vision sensor and is disposed inside the target acquiring device.

9. The target acquiring device of claim 5, wherein the target acquiring device further includes an evacuation device, attached to at least one hole on the curved surface.

10. The target acquiring device of claim 1, wherein the vision sensor is any one or more cameras or laser sensors.

11. The target acquiring device of claim 1, further comprising:
a third base;
a multi-degree-of-freedom attachment system, including a first end attached to the third base and a second end attached to the target acquiring device.

12. The target acquiring device of claim 11, wherein the multi-degree-of-freedom attachment system is capable to adjust the attitude of the target acquiring device so as to adjust the axis of acquisition of a target to the direction towards the target.

13. The target acquiring device of claim 11, further comprising a servo drive system wherein the servo drive system includes:
at least one drive system, configured to drive the multi-degree-of-freedom attachment system and adjust the target acquiring device to the position of one or more degree of freedom; and
a control module, coupled to the vision sensor and at least one drive system, that controls the drive systems through the image signal transmitted by the vision sensor.

14. The target acquiring device of claim 11, wherein the multi-degree-of freedom attachment system includes a multi-connecting-rod structure, wherein the multi-connecting-rod structure includes at least one connecting rod and at least one hinge, and wherein at least one end of each connecting rod connects one of the hinges and each hinge connects at least one end of one of the connecting rods.

15. The target acquiring device of claim 11, further comprising at least one drive system, wherein each drive system attaches to one of the at least one hinge and drives the hinge to rotate.

16. A method to control a mechanical arm, wherein the mechanical arm comprises:
a control module, configured to control the movement of the mechanical arm;
a target acquiring device, configured to acquire a target located on an axis of acquisition of a target,
wherein the axis is an extension line going through the target acquiring device, wherein the target acquiring device includes a vision sensor, located on the axis of acquisition of a target and configured to acquire the image on the direction of the axis of acquisition of a target; and
wherein the method to control the mechanical arm comprises:
the vision sensor acquiring an image where the target on the axis of acquisition of a target is included; and
the vision sensor transmitting the image to the control module;
the control module driving the mechanical arm and adjusting the axis of acquisition of a target to align the target.

17. The method of claim 16, further comprising:
the control module determining the location of the target relative to the target acquiring device;
in accordance with the foresaid location, the control module controlling the multi-degree-of-freedom attachment system to move the target acquiring device along the axis of acquisition of a target until the distance between the target acquiring device and the target reaches a default;
the control module controlling the target acquiring device to acquire the target.

18. The method of claim 17, wherein the control module moves the target acquiring device along the axis of acquisition of a target until the distance between the target acquiring device and the target reaches a default;
wherein the control module in real time receives images transmitted from the vision sensor and in real time determines the location of the target relative to the target acquiring device;
wherein the control module moves the target acquiring device along the axis of acquisition of a target until the distance between the target acquiring device and target reaches a default.

19. The method of claim 17, wherein the target acquiring device includes a sucking device, wherein the sucking device is coupled to an air pump which is disposed in the robotic arm through an air pressure passage, wherein the air pump runs and a negative pressure is generated between the sucking device and the surface of the target when the sucking device touches the surface of the target.

20. The method of claim 17, wherein the target acquiring device includes a robotic arm, wherein the control module controls the robotic arm to grasp the target when the distance between the robotic arm and the target reaches a default.
